(19) United States
(12) Patent Application Publication
(10) Pub. No.: US 2007/0047075 A1
(43) Pub. Date: Mar. 1, 2007

(54) DEVICE FOR CHANGING OBJECTIVES IN OPTICAL DEVICES, PARTICULARLY IN MICROSCOPES

(75) Inventors: Hubert Wahl, Stadtroda (DE); Andreas Hermann, Gleichen (DE); Mario Sondermann, Goettingen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Carl Zeiss MicroImaging GmbH

(21) Appl. No.: 11/467,242

(22) Filed: Aug. 25, 2006

(30) Foreign Application Priority Data
Aug. 25, 2005 (DE) 10 2005 040 834.6

(51) Int. Cl. G02B 21/00

(52) U.S. Cl. 359/381

(57) ABSTRACT

The invention is directed to a device for changing objectives which are arranged in a work position in the optical axis of a beam path of an optical device at a distance from the object to be examined. The optical device has in particular a housing with a front surface and rear surface and side surfaces and focusing means for the objectives to be changed. Receptacles are provided which are connected to the housing of the device directly or by intermediate members and in which the objectives are arranged. The device comprises first means for the linear movement and/or combined rotational and swiveling movement of the receptacle in up to three coordinates, by which an objective can be positioned in the work position in the optical axis of the beam path of the device and outside the optical axis in a standby position.

### CROSS-REFERENCE TO RELATED APPLICATION

This application claims priority of German Application No. 10 2005 040 834.6, filed Aug. 25, 2005, the complete disclosure of which is hereby incorporated by reference.

### BACKGROUND OF THE INVENTION

a) Field of the Invention

The invention is directed to a device for changing objectives in optical devices, particularly in microscopes, in which the space between the objective and the object is limited due to the construction of the microscope and due to the use of objectives of different magnification and manipulators.

b) Description of the Related Art

Microscopes with manipulators are frequently used in practice for micromanipulation of objects or specimens. Due to their space requirement, these highly-sensitive manipulators substantially limit the freedom of movement of the devices for changing objectives.

U.S. Pat. No. 6,359,731 B1 describes an arrangement for changing optical elements, particularly objectives, in which the elements which are arranged in a guided holder can be changed by linear movements of the holder parallel, perpendicular and/or at an inclination to the optical axis of the beam path.

U.S. Pat. No. 6,437,911 B1 describes an arrangement for changing objectives in which the objectives to be changed are arranged in a swiveling mechanism that is provided with holders. When changing the objectives, the holders are swiveled around an axis at a determined angle so that first one, then the other objective is positioned in the beam path. Driving can be carried out manually or by means of a motor.

Other devices for changing objectives in microscopes are known. The most well-known and the most commonly used is a turret arrangement which is outfitted with different objectives.

For example, EP 1 093 002 A2 describes a device for changing objectives in microscopes in which the axis of rotation of a turret carrying the objectives is provided at an inclination to the optical axis of the microscope beam path. While this arrangement attempts to free the object space as far as possible for the manipulators when changing objectives, it is not successful particularly when switching between high-magnification objectives because the distance between the front of the objective and the object is very small with objectives of this kind.

German Application DE 10 2004 032 556 1 likewise suggests a changing device for optical components and structural components, particularly for microscopes with manipulators, in which the objective turret is arranged in such a way that the component which lies diametrically opposite from the component located in the beam path with reference to the axis of rotation of the turret is located next to the microscope stand. In this case also, the components can also be objectives, and therefore the space between the objective and object can be limited when using high-magnification objectives.

Other Approaches Considered

To overcome these deficiencies at least in part, various principles have been determined for changing objectives with objective turrets in microscopes.

For example, when changing objectives, the objective turret is initially moved away from the object, which can be achieved by a lifting or tilting movement. The objective is then changed by a rotational movement, and the objective turret is moved again into the work position in the principal beam path of the microscope.

In another arrangement, an objective to be changed is initially raised in its holder and displaced until another objective occupies its position in the beam path. This other objective is then lowered into its work position.

In another principle for objective changing, the objective to be changed is tilted in its holder and displaced along an axis until a second objective arrives in a position in which it need only be tilted into the work position.

### OBJECT AND SUMMARY OF THE INVENTION

Therefore, it is the primary object of the invention to provide a device for changing objectives in microscopes which makes it possible to change objectives in a simple and reliably functioning manner even when the space between the objective and object is substantially limited without interfering with tools or manipulators that may be located within this space.

According to the invention, this object of the invention is met in a device which is designed according to the preamble of the main claim and which has the characterizing means of this claim. Details and further constructions of the invention are disclosed in the subclaims.

An advantageous construction of the invention is provided when the first means are provided for the linear displacement of the receptacle along at least one coordinate and/or for the rotational or swiveling movement of the receptacle around at least one coordinate of a coordinate system.

Further, it is advantageous when the first means comprise guides which are connected to the housing and which are arranged in a plane or in different planes with reference to the front surface of the housing and enclose suitable solid angles with respect to the optical axis of the beam path of the device, when slides, each of which carries a receptacle, are mounted in the guides, and when second means are provided for driving the slides manually or by motor. In this way, an objective can be changed by means of a simple linear movement of the receptacle in a longitudinal guide. Since, in this way, the movement of the receptacle with the objective arranged therein extends at a defined angle and, therefore, parallel to the boundary of the work space, conflicts with manipulators, for example, are prevented to a great extent.

Further, in an embodiment example of an advantageous changing device the first means comprise guides which are connected to the housing and in which the receptacle is displaced in one coordinate and/or can be rotated around this coordinate, and the rotation of the receptacle with the objective to be positioned in the beam path is carried out around the respective coordinate when it lies in a plane in which the optical axis of the respective beam path is also located. The objective is changed in this case by means of a combined rotating-sliding movement of the receptacle around one or more coordinates.

Further, it can be advantageous when the first means are provided for implementing a rotating and lifting movement of the receptacle.

In another advantageous construction of the invention, at least one guide bush which is provided with a lead cam having a gradient is fixedly arranged at the housing of the device, a threaded sleeve which is fixedly connected to the receptacle being displaceably supported in the guide bush by a pin which is guided in the lead cam, and the threaded sleeve has an internal thread which is in operative connection with a threaded spindle which can be rotated manually or by motor and which is mounted in the housing. An embodiment form of the invention of this kind advantageously results when at least one guide bush which is provided with a lead cam having a gradient is fixedly arranged at the housing or stand of the device, and a spindle nut which is fixedly connected to the receptacle is displaceably supported in the guide bush by a guide pin which is guided in the lead cam, and when the threaded sleeve is in operative connection by its internal thread with a threaded spindle which can be rotated manually or by motor and which is mounted in the housing or stand.

By means of the invention, objective changing mechanisms are realized which provide simple and functional changing devices which have an economical construction and which can be actuated manually or by motor even in limited space due to simple kinematics.

The invention will be described more fully in the following with reference to an embodiment example.

### BRIEF DESCRIPTION OF THE DRAWINGS

In the accompanying drawings:

FIG. 1 shows a device with a linear displacement of the objectives to be changed;

FIG. 2 shows a device with a combined sliding-rotating movement of the objectives; and

FIG. 3 shows a device with a superimposed rotating-lifting movement of the objectives.

### DESCRIPTION OF THE PREFERRED EMBODIMENTS

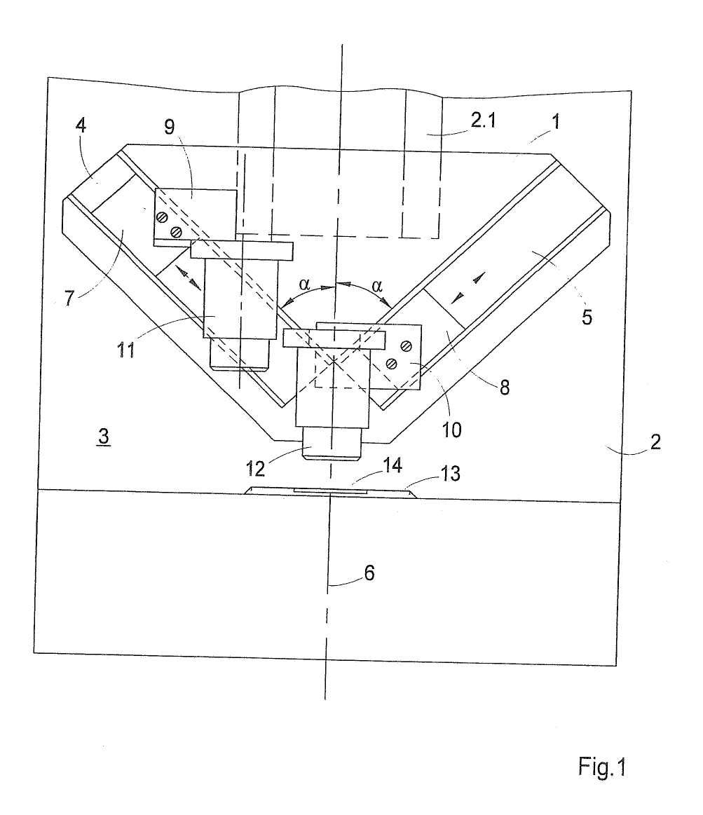

The device 1 shown in FIG. 1 for changing objectives is arranged at a stand or at a Z-guide 2.1 of a housing 2 of a microscope or of an optical device. The Z-guide 2.1 is generally arranged at the front surface 3 of the housing 2. The device 1 comprises guides 4 and 5 which enclose planes or solid angles α of identical or different dimensions with the optical axis 6, for example, of the observation beam path of the microscope or of the optical device. A slide 7; 8 is mounted in each guide 4; 5 so as to be linearly displaceable. Each slide 7 and 8 carries a receptacle 9; 10 at which the objectives 11 and 12 to be moved into the beam path are arranged. The object 14 to be observed is located on an object carrier 13 beneath the objective 12 which is arranged in the optical axis 6 of the beam path.

In order to change objectives, the slide 8, for example, is displaced along the guide 5 together with the receptacle 10 and the objective 12 located at the latter, and the objective is accordingly removed from the optical axis 6 and therefore from the beam path. By displacing the other slide 9 along the guide 4, the objective 11 can then be positioned in the optical axis 6 and therefore in the beam path.

In contrast to known changing devices, the embodiment form of the objective changing device, according to the invention, which is shown in FIG. 1 is characterized by simple kinematics having only linear movements of the elements taking part in the changing of objectives. This results in a simpler, more economical construction, and the space requirement lies within non-critical ranges for the application. Objectives can be changed either manually or by motor in a highly precise manner and substantially free of vibrations. An arrangement of more than two guides in different planes and at different solid angles (not shown in FIG. 1) with reference to the optical axis 6 can also make it possible to change more than two objectives. The slides 7 and 8 can also be connected to one another by coupling elements so as to realize a simultaneous movement of the objectives 11 and 12 to be changed into a new position.

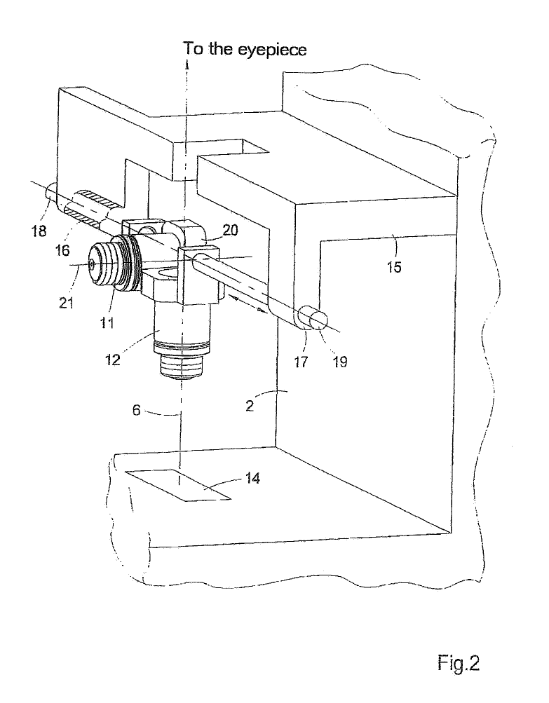

FIG. 2 shows a simplified view of another construction of the changing device according to the invention for changing objectives by means of a combined rotating and longitudinal movement. This device comprises a holder 15 which is connected to the housing 2 of the device or microscope and which has bearings 16 and 17 in which bearing pins 18 and 19 of a receptacle 20 are supported so as to be rotatable and displaceable. The objectives 11 and 12 to be changed are arranged at the receptacle 20. The holder 15 itself can be arranged at the stand or housing 2 of the device or microscope so as to be adjustable in height (not shown in FIG. 2).

In the construction according to FIG. 2, the objectives 11 and 12 can be changed in three steps. In a first step, the receptacle 20 with the objectives 11 and 12 located thereon is tilted around the axis of rotation 21 of the bearing pins 18; 19 extending perpendicular to the optical axis 6 until the objective 12 arranged in the optical axis 6 is at a sufficient distance from the object 14 to be observed. In a second step, the receptacle 20 is displaced along the axis of rotation 21 until the center axis of the other objective 11 is located in a plane in which the optical axis 6 also lies. In a third step, the receptacle 20 is swiveled farther around the axis of rotation 21 until the objective 11 is positioned in its work position in the optical axis 6.

This changing device also provides a simple and economical construction which makes it possible through its simple kinematics to change the objectives 11; 12 precisely, without vibrations and manually in a simple manner. Since the objectives 11; 12 to be exchanged are rigidly coupled to one another by the receptacle 20, an objective can be changed with only one operator control (not shown).

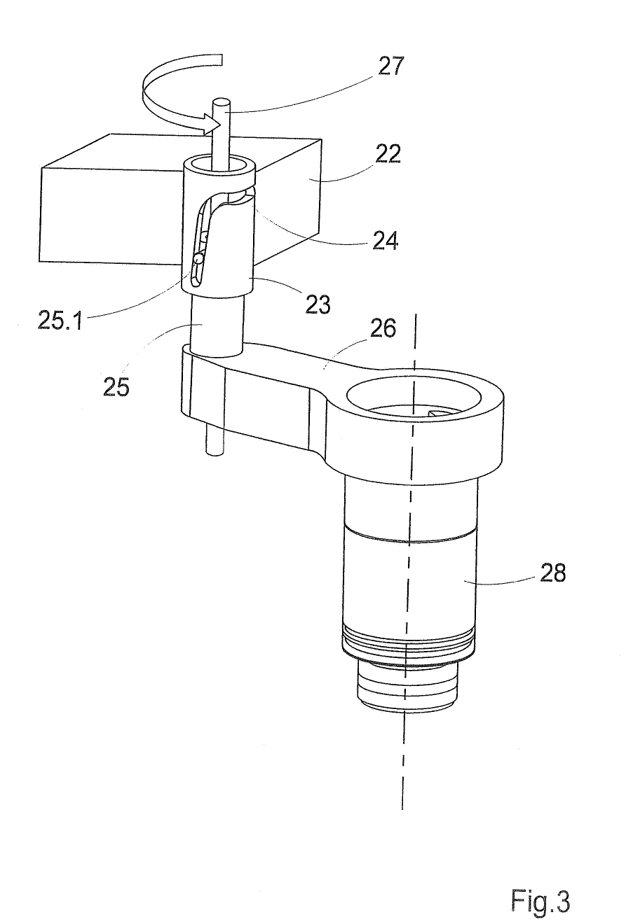

FIG. 3 shows another technical construction of a device for changing an objective in which the objective can be moved from one position, for example, a standby position, into a work position. This device is fixedly connected to a holder 22 which is arranged at the stand or housing of the optical device or microscope. The device has a guide bush 23 with a lead cam 24. The guide bush 23 is fixedly arranged at the holder 22. A threaded sleeve 25 having an internal thread is mounted in the guide bush 23 so as to be rotatable and longitudinally displaceable, an objective carrier 26 being fixedly arranged at this threaded sleeve 25. The threaded sleeve 25 has a guide pin 25.1 which is guided in the lead cam 24. Further, a threaded spindle 27 is rotatably supported in the holder 22.

If a plurality of objectives are to be moved out of a standby position into a work position, a device of the type mentioned above (according to FIG. 3) must be provided at the optical device or microscope for each objective to be adjusted.

This changing device makes it possible to change objectives with simple kinematics in two steps by executing a rotating-lifting movement of the objective carrier 26. A movement of the threaded sleeve 25 and, therefore, also of the objective carrier 26 in perpendicular direction is generated by rotating the threaded spindle 27. In doing so, the guide pin 25.1 moves along the lead cam 24. Due to the fact that the guide bush 23 is fixedly connected to the holder 22, a rotational movement of the threaded sleeve 25 is superimposed on the lifting movement of the threaded sleeve 25, and therefore of the objective carrier 26, which is caused by the rotation of the threaded spindle 27, and the objective carrier 26 with the objective 28 located therein is accordingly moved out of the position which it had occupied up until then.

This device is likewise characterized by kinematics which are realized in a simple manner and which make it possible to change objectives in only two steps. The threaded spindle 27 can be driven manually as well as by motor. The individual movements of the individual threaded spindles can be coupled in a simple manner by suitable gear members so that it is possible to change objectives with only one operator control.

While the foregoing description and drawings represent the present invention, it will be obvious to those skilled in the art that various changes may be made therein without departing from the true spirit and scope of the present invention. REFERENCE NUMBERS
1 device
2 housing
2.1 Z-guide
3 front surface
4; 5 guide
6 optical axis
7; 8 slides
8; 10 receptacle
11; 12 objective
13 object carrier
14 object
15 holder
16; 17 bearing
18; 19 bearing pin
20 receptacle
21 axis of rotation
22 holder
23 guide bush
24 lead cam
25 threaded sleeve
25.1 guide pin
26 objective carrier
27 threaded spindle
28 objective

What is claimed is:

1. A device for changing objectives which are arranged in a work position in the optical axis of a beam path of an optical device at a distance from the object to be examined, wherein the optical device has in particular a housing with a front surface and rear surface and side surfaces and focusing means for the objectives to be changed, comprising receptacles which are connected to the housing of the device directly or by intermediate members and in which the objectives are arranged, said device comprising:
first means for the linear movement and/or combined rotational and swiveling movement of the receptacle in up to three coordinates, by which an objective can be positioned in the work position in the optical axis of the beam path of the device and outside the optical axis in a standby position.

2. The device according to claim 1, wherein the first means are provided for the linear displacement of the receptacle along at least one coordinate and/or for the rotational and swiveling movement of the receptacle around at least one coordinate of a coordinate system.

3. The device according to claim 1, wherein the first means comprise guides which are connected to the housing and which are arranged in a plane or in different planes with reference to the front surface of the housing and enclose suitable solid angles with reference to the optical axis of the beam path of the device, wherein slides, each of which carries a receptacle, are mounted in the guides, and wherein second means are provided for driving the slides manually or by motor.

4. The device according to claim 1, wherein the first means comprise guides which are connected to the housing and in which the receptacle is displaced in one coordinate and/or can be rotated around this coordinate, wherein the rotation of the receptacle with the objective to be positioned in the beam path is carried out around the respective coordinate when this coordinate lies in a plane in which the optical axis of the respective beam path is also located.

5. The device according to claim 1, wherein the first means are provided for implementing a rotational and lifting movement of the receptacle or of an object carrier.

6. The device according to claim 5, wherein at least one holder is fixedly provided at the housing of the device, a guide bush which is provided with a lead cam having a gradient is fixedly arranged at the housing of the device, a threaded sleeve which is fixedly connected to the receptacle or to an object carrier being displaceably supported in the guide bush by a guide pin which is guided in the lead cam, and wherein the threaded sleeve has an internal thread which is in operative connection with a threaded spindle which can be rotated manually or by motor and which is mounted in the housing or the holder.
